(19) United States
(12) Patent Application Publication
(10) Pub. No.: US 2004/0261932 A1
(43) Pub. Date: Dec. 30, 2004

(54) Non-stick coating having improved scratch and abrasion resistance

(76) Inventors: Jean-Pierre Buffard, Tresserve (FR); Claudine Gardaz, Bloye (FR)

Correspondence Address: BACHMAN & LAPOINTE, P.C., 900 CHAPEL STREET, SUITE 1201, NEW HAVEN, CT, 06510, US

(21) Appl. No.: 10/484,761

(22) PCT Filed: Jan. 22, 2002
(86) PCT No.: PCT/FR02/00260

(30) Foreign Application Priority Data
Jul. 26, 2001 (FR) 0110021

(51) Int. Cl. C03B 29/00; B32B 15/08

(52) U.S. Cl. 156/89.11; 428/626

(57) ABSTRACT

The non-stick coating of the invention comprises at least one primer layer comprising a fluorocarbon resin and inorganic particles, the primer layer being applied on a support and covered in one or more finishing layers based on fluorocarbon resin. The inorganic particles are ceramic particles having a mean diameter less than 4 μm. The coating is particularly suitable for cooking utensils.

The present invention relates to a non-stick coating presenting improved resistance to scratching and abrasion.

The invention also provides articles and in particular cooking utensils that include a coating of the invention.

The non-stick coatings commonly in use for coating cooking articles are based on a fluorocarbon resin, such as polytetrafluoroethylene (PTFE).

Conventionally, such coatings are formed by applying an adhesion “first” layer based on a fluorocarbon resin directly to the support, said layer commonly being referred to as a “primer” layer, with said first layer then being covered in one or more finishing layers, likewise based on fluorocarbon resin.

Such PTFE-based coatings are known for their non-stick properties, and also for their resistance both to chemical attack and to high temperatures.

Nevertheless, they present the drawback of being sensitive to scratching and abrasion, which means that this type of coating quickly becomes worn.

To remedy that major drawback and to obtain non-stick coatings that present improved resistance to scratching and abrasion, a first solution consists in forming a hard underlayer or a hard base between the support and the primer layer, said underlayer forming a barrier which presents scratches reaching the surface of the support.

A hard underlayer can be formed in particular by a polymer such as polyamide-imide (PAI) and/or oxy-1,4-phenylene-oxy-1,4-phenylene-carbonyl-1,4-phenylene (PEEK), as taught in international patent applications WO 00/54895 and WO 00/54896 in the name of the Applicant.

A hard base can be constituted in particular by an enamel, a stainless steel, or alumina.

An alumina hard base can be deposited on the support by plasma sputtering.

In the particular circumstance of a support made of aluminum, the alumina hard base can also be formed directly on the support, by anodic oxidation thereof. A coating including such a hard base which provides particularly satisfactory resistance to scratching and abrasion is described by the Applicant in its application EP 0 902 105.

As an alternative to introducing a hard underlayer or a hard base, a second solution for reinforcing PTFE-based coatings consists in including reinforcing fillers in one of the layers forming said coatings, and in particular in the primer layer.

Amongst the various reinforcing fillers presently in use, mention can be made of inorganic particles such as particles of mica (EP 0 389 966), of silica, of mullite (FR 2 756 875), or of metal flakes or metal oxide flakes, in particular aluminum flakes (EP 0 656 831). The mean dimensions for the inorganic particles as mentioned by the two European documents lie in the range 5 microns (μm) to 200 μm.

Those solutions whereby PTFE-based coatings are reinforced by means of inorganic particles have been criticized and found unsatisfactory in terms of resistance to scratching and abrasion by document EP 1 016 466.

In order to avoid reinforcing coatings of that type, EP 1 016 466 describes a coating in which the objective is to deflect the abrasive forces from the outside surface of the coating: to do that, it has a primer layer based on fluorocarbon resin and containing ceramic inorganic particles which extend beyond said primer layer, the primer layer being applied to the support and being covered in one or two top layers based on fluorocarbon resin, said top layers covering all of the ceramic particles that project beyond the primer layer.

The ceramic particles present in the primer layer as taught in that prior art are of dimensions such that they deform the surface of the top layers and thus provide deflection zones in the outer surface of the coating, said deflection zones then enabling the abrasion forces to be deflected, thus increasing the abrasion resistance of the coating.

The mean dimensions of the ceramic particles enabling said deflecting zones to be formed as taught in EP 1 016 466 are a function of the total thickness of the dry coating, as follows: the ratio of total thickness of dry coating over the diameter of the longest of said ceramic particles lies in the range 0.8 to 2.0. That document specifies that such particles have a mean size of not less than 14 μm, advantageously of not less than 20 μm, and preferably of not less than 25 μm.

That prior art does indeed tend to satisfy the problem of providing a non-stick coating which withstands scratching and abrasion, but it does so in indirect manner since it tends to protect the surface of the coating by deflecting the abrasion forces, thus making it possible to avoid puncturing the coating itself.

Nevertheless, they present the major drawback of associating the size of the ceramic particles with the thickness of the final coating that is to be obtained: particles that are too small do not enable the desired technical effect to be obtained since they do not generate any deflection points on the surface of the coating; and a contrario, particles that are too large run the risk of puncturing the coating and of spoiling its non-stick and low friction properties.

Furthermore, the outer surface of the coating is then by definition deformed by the presence of the deflection zones, which over time become eroded under the action of friction forces, and can in the long run lead to bare zones being formed, thereby partially reducing the non-stick properties of the coating.

The object of the present invention is thus to propose a coating which while conserving excellent non-stick properties, presents of itself and not by any deflection effect, improved resistance to scratching and abrasion without deforming its outside surface and without necessarily requiring a specific hard base or hard underlayer to be included in the particular application to cooking utensils.

The present invention thus provides a coating comprising at least a primer layer comprising a fluorocarbon resin and inorganic particles, the primer layer being applied to a support and itself being covered in one or more finishing layers based on fluorocarbon resin.

According to the invention, the inorganic particles are ceramic particles having a mean diameter of less than 4 μm and they are fully included in the primer layer, whose outside surface is thus not deformed by the presence thereof.

Advantageously, the ceramic particles suitable for the present invention present both a high level of hardness, greater than about 1500 on the Vickers scale, and remarkable resistance to melting, having melting points higher than 2000° C.

Preferably, the mean diameter of the ceramic particles lies in the range 0.01 μm to 3 μm approximately, advantageously in the range 0.05 μm to 2 μm approximately, more advantageously in the range 0.1 μm to 1 μm approximately, and is preferably about 0.5 μm.

The Applicant has found that in spite of their small dimensions, the ceramic particles of the invention give the coating resistance to scratching and abrasion that is considerably better than that of coatings including inorganic particles as described in the prior art, regardless of whether those particles are in the form of mica, mullite, or metal flakes, or whether they are of greater or much greater dimensions as recommended in the prior art.

This observation is particularly surprising and unexpected in that the remarkable physical and chemical properties of ceramic particles in accordance with the invention, and in particular extreme hardness associated with a high melting point, are effective, even when the particles are of extremely small dimensions.

In addition, and contrary to the assumptions of document EP 1 016 466, this effective resistance to scratching and abrasion is obtained in the absence of any deflection zones being formed to deflect abrasion forces; in this respect, the present invention overcomes the prejudice put forward by that teaching.

The ceramic particles used in the context of the present invention preferably comprise at least one element selected from metal carbides, metal nitrides, metal borides, metal oxicarbides, metal oxinitrides, metal carbonitrides, and metal oxides.

Nevertheless, there is no reason why a mixture comprising two or more of the above-mentioned ceramic particles should not be used.

Preferably, the metal is a refractory metal or a mixture of refractory metals. In which case, it is possible in particular to mention mixed carbides and mixed nitrides which are respectively carbides or nitrides comprising at least two different refractory metals

Preferably, the refractory metals are selected from: titanium (Ti); zirconium (Zr); hafnium (Hf); tantalum (Ta); niobium (Nb); tungsten (W); molybdenum (Mo); boron (B); silicon (Si); beryllium (Be); and aluminium (Al)

Methods of obtaining carbides or nitrides (whether they are mixed or otherwise), oxicarbides, oxinitrides, and/or carbonitrides of refractory metals as mentioned above are described in the following documents FR 2 609 461, EP 0 543 753, and WO 99/47454.

Implementing the teaching of FR 2 609 461 makes it possible to obtain ceramic particles that are uniform both in terms of chemical composition and in terms of physical properties, with reproducible grain sizes.

In particular, the ceramic particles described by EP 0 543 753 present particularly high hardness, specifically hardness greater than 2000 on the Vickers scale, associated with specific gravity that is also high, which may be situated in the range 5 to 16, approximately.

Furthermore, because of their quasi-spherical shape, ceramic particles as taught by EP 0 543 753 provide better resistance to impact from “large” particles striking the multilayer coating of the invention.

In still more preferable manner, the metal is at least one of the elements selected from Ti, Zr, and Hf.

The following ceramic particles: TiC, ZrC, HfC, TiN, ZrN, and HfN combine both the great hardness and high melting point characteristics mentioned above with characteristics similar to those of metals, in particular in terms of thermal conductivity.

In an advantageous version of the invention, the proportion by weight of ceramic particles in the primer layer, after firing, lies in the range 1% to 40%, advantageously in the range 3% to 25%, and preferably in the range 5% to 15%.

These relatively high quantities by weight of ceramic fillers also confer a surprising result on coatings of the invention. Contrary to present expectations, namely that adding inorganic fillers in excess of 15% spoils the cohesion of the layer containing them (so that cracks and crazing appear) thus reducing resistance to scratching and non-stick properties, the Applicant has found that the cohesion of the primer layer is, in fact, strengthened thereby.

The invention also provides a method of making a coating on a support, the method comprising the following steps:

uniformly incorporating ceramic particles of mean diameter less than 4 μm in a composition comprising a fluorocarbon resin so as to form a primer layer;

applying at least one primer layer containing ceramic particles on the support, the primer layer forming a smooth surface;

applying finishing layer(s) based on fluorocarbon resin on the primer layer(s); and then

sintering all of the layers at 400° C. to 420° C.

The invention applies in particular to cooking utensils coated on the inside and/or on the outside with a non-stick coating.

The support of such utensils can be made of aluminum, steel, enameled steel, stainless steel, glass, or ceramic.

The support may optionally be subjected to prior treatment depending on whether a rough or a smooth support is desired: the support can thus be treated chemically, e.g. by acid etching, or mechanically, in particular by sand blasting.

The primer and finishing layers comprise a fluorocarbon resin.

The fluorocarbon resin can be PTFE, perfluoroalkoxy (PFA), or fluorinated ethylene-propylene (PEP), or a mixture of these compounds.

The primer and finishing layers are deposited on the support, optionally after it has been subjected to prior treatments, by spraying (using a spray gun), by silkscreen printing, e.g. using the method described in document FR 2 689 037 in the name of the Applicant, by stamping, or by coating by means of a roller.

By way of illustration, three examples of coatings of the invention are described below.

### EXAMPLE 1

The coating of Example 1 is constituted by a primer layer applied to the support, and then covered in two finishing layers, constituting an intermediate layer itself covered by a top or finishing layer.

The compositions of each of the three layers are given below by way of example in percentages by weight:

| | |
|---|---|
| Primer layer | |
| An aqueous suspension of polyamide-imide (PAI) | 18 to 35 |
| (10% to 15% dry extract) | |
| N-methylpyrrolidone | 0 to 12 |
| An emulsion of film-forming and spreading | 4 to 10 |
| agent | |
| A dispersion of fluorocarbon resin(s) | 15 to 35 |
| (50% to 60% dry extract) | |
| Colloidal silica (30% dry extract) | 10 to 16 |
| TiC powder (0.1 μm to 1 μm) | 1 to 10 |
| Intermediate layer | |
| A dispersion of fluorocarbon resin(s) | 11 to 89 |
| (50% to 60% dry extract) | |
| An emulsion of film-forming and spreading | 10 to 20 |
| agent | |
| TiO₂ covered mica flakes | 0.1 to 1.6 |
| Pigments (carbon black) | 0.1 to 1.6 |
| Top finishing layer | |
| PTFE dispersion (60% dry extract) | 78 to 90 |
| Emulsion of film-forming and spreading | 10 to 20 |
| agent | |
| TiO₂ covered mica flakes | 0.1 to 1.6 |

The primer layer is preferably in the form of a uniform composition of ceramic particles with the fluorocarbon resin.

By ensuring that the distribution of ceramic particles is uniform, i.e. homogeneous without any clumping, it is possible to produce a primer layer that is coherent and uniform on the surface and throughout its thickness, and thus a primer layer that is free from any faults, cracks, crazing, bubbles, . . . .

In this example, the titanium carbonate (TiC) incorporated in the primer layer was constituted by a mixture of ceramic particles of mean diameter lying in the range 0.1 μm to 1 μm.

The primer layer was deposited on the support to form a smooth surface, i.e. an outside surface that is plane without any deflection zones.

The primer layer was then allowed to dry so as to obtain a primer layer of thickness lying in the range 4 μm to 16 μm; thereafter the intermediate layer was applied followed by the top finishing layer, the assembly constituted by the intermediate and top finishing layers presenting thickness lying in the range 10 μm to 25 μm.

After all three layers had dried, a sintering step was performed at 400° C. to 420° C. on the coating obtained in this way for a period of 3 minutes to 7 minutes.

A coating was obtained that bonded strongly to the support and that presented improved performance in terms of resistance to scratching; tests showed that intensive cooking of food using metal spatulas on a cooking utensil, specifically a frying pan, covered in a coating in accordance with the first example above, said cooking representing one to two years normal use of a cooking utensil, gave rise to hardly any scratching of the coating, when compared with identical intensive cooking performed using plastic spatulas on a cooking utensil in which the primer layer did not include any particles of TiC.

In an advantageous version of the invention, the coating may further comprise a hard underlayer between the support and the primer layer.

The presence of a hard underlayer combines the effects of the present invention with those that are conferred by hard underlayers as described in the prior art, thereby further improving resistance to scratching and abrasion.

In a preferred version, the coating may also comprise at least two primer layers, each containing ceramic particles having a mean diameter of less than 4 μm.

A second embodiment of a coating combining these two variants of the invention is described below.

### EXAMPLE 2

The coating was made by depositing:

a hard underlayer having no fluorocarbon resin as described in WO 00/54895 or WO 00/54896, said underlayer being applied directly to the support;

two primer layers, of identical composition, applied in succession to the underlayer;

an intermediate layer covering the second primer layer; and then

a top finishing layer covering the intermediate layer.

The underlayer having no fluorocarbon resin was based on poly ether ether ketone (PEEK) i.e. oxy-1,4-phenylene-oxy-1,4-phenylene-carbonyl-1,4-phenylene.

The two primer layers were identical in composition to the single primer layer of Example 1, both of them containing TiC comprising a mixture of particles with a mean diameter lying in the range 0.1 μm to 1 μm.

The total thickness constituted by the two primer layers lay in the range 4 μm to 16 μm.

Similarly, the intermediate and top finishing layers were of respective compositions identical to those described in Example 1 above.

Prior to applying the PEEK-based underlayer, the support may optionally be subjected to chemical or mechanical treatment in order to make its surface rough.

The underlayer was applied in the form of an aqueous dispersion using a spray gun.

After firing, such an underlayer is either constituted solely by PEEK, as taught in WO 00/54895, or at least 50% PEEK with the remainder being made up of pure or mixed thermostable polymers (such as polyphenylene sulfide, polyetherimide, polyimide, poly ether ketone, polyethersulfone, polyamide-imide) and inert fillers selected from metal oxides, silica, mica particles, or flaky fillers, as taught in WO 00/54896.

The primer, intermediate, and top finishing layers were then applied in succession using the same procedure as that described above for Example 1.

The entire coating was subsequently sintered at 400° C. to 420° C. for 3 minutes to 7 minutes.

In a variant of the invention, the coating may further comprise a hard base between the support and the primer layer.

A third example of a coating combining a hard base and the application of two primer layers is described below.

### EXAMPLE 3

The coating was constituted by;

a hard base;

two primer layers of identical composition applied successively onto the hard base;

an intermediate layer covering the second primer layer; and then

a finishing layer covering the intermediate layer.

The hard base could be of the ceramic type being formed on the support by plasma sputtering a layer of Al₂O₃/TiO₂, for example. Alternatively it could be of the metal type, being made on the support by plasma sputtering stainless steel powder.

The hard base could also be obtained directly on the support prior to applying the primer layer(s), by proceeding with hard anodizing or with micro-arc anodizing as described in EP 0 902 105 in the name of the Applicant.

The presence of the hard base serves to isolate the coating from the support in the event of a deep scratch.

The primer, intermediate, and top finishing layers were then applied in succession using the procedures described above for Examples 1 and 2, and finally the entire coating was sintered at 400° C. to 420° C. for 3 minutes to 7 minutes.

Clearly in each of the three examples described above, it is possible to perform chemical or physical treatment on the support prior to applying the hard underlayer and/or the first or primer layer.

Naturally, the invention is not limited to the examples described above, and the improved properties of resistance to scratching and abrasion were measured on cooking utensils having inside surfaces for coming directly into contact with food, and covered in a coating in accordance with the invention.

Such a coating can naturally be used for other purposes in the field of cooking, for coating the inside and/or the outside of any type of cooking utensil, hot plates, grill, . . . ; the coating can also be used for coating any sliding surface, and in particular surfaces of smoothing irons, for example.

1-17. (cancelled)

18. A non-stick coating presenting improved resistance to scratching and abrasion, the coating comprising at least one primer layer comprising a fluorocarbon resin and inorganic particles, the primer layer being applied to a support and being covered in at least one finishing layer based on fluorocarbon resin, the inorganic particles being ceramic particles which have a mean diameter of less than 4 μm and which comprise at lest one constituent selected from the group consisting of metal carbides, metal nitrides, metal borides, metal oxicarbides, metal oxinitrides, and metal carbonitrides, and in that the proportion by weight of said ceramic particles in the primer layer, after firing, lies in the range 1% to 40%.

19. A non-stick coating according to claim 18, wherein said proportion is in the range of 3 to 25%.

20. A non-stick coating according to claim 18, wherein said proportion is in the range of 5 to 15%.

21. A coating according to claim 18, wherein the mean diameter of the ceramic particles lies in the range of 0.01 μm to 3 μm approximately.

22. A coating according to claim 18, wherein the mean diameter of the ceramic particle lies in the range of 0.05 μm to 2.0 μm approximately.

23. A coating according to claim 18, wherein the mean diameter of the ceramic particles is in the range of 0.1 μm to 1.0 μm approximately.

24. A coating according to claim 18, wherein the mean diameter of the ceramic particles is about 0.5 μm.

25. A coating according to claim 18, wherein the ceramic particles present high hardness, in excess of 1500 on the Vickers scale.

26. A coating according to claim 18, wherein the metal is at least one of the elements selected from: titanium (Ti); zirconium (Zr); hafnium (Hf); tantalum (Ta); niobium (Nb); tungsten (W); molybdenum (Mo); boron (B); silicon (Si); beryllium (Be); and aluminum (Al).

27. A coating according to claim 18, comprising at least two primer layers.

28. A coating according to claim 18, wherein a total thickness of the at least one primer layer lies in the range of 4 μm to 16 μm.

29. A coating according to claim 18, further comprising a hard underlayer between the support and the at least one primer layer.

30. A coating according to claim 29, wherein the hard underlayer does not contain any fluorocarbon resin.

31. A coating according to claim 18, further comprising a hard base between the support and the at least one primer layer.

32. A cooking utensil coated by a coating in accordance with claim 18.

33. A method of making a coating according to claim 18 on a support, the method comprising the following steps:
uniformly incorporating ceramic particles of mean diameter less than 4 μm in a composition comprising a fluorocarbon resin so as to form a primer layer, the ceramic particles comprising at least one element selected from the group consisting of metal carbides, metal nitrides, metal borides, metal oxicarbides, metal oxinitrides, and metal carbonitrides, the proportion by weight of said ceramic particles in the primer layer, after firing, lying in the range of 1% to 40%;
applying at least one primer layer containing said ceramic particles on the support so that the primer layer forms a smooth surface;
applying at least one finishing layer based on fluorocarbon resin on the at least one primer layer; and
sintering all of the layers at 400° C. to 420° C.

34. A method according to claim 33, further comprising depositing at least one second primer layer containing ceramic particles of mean diameter less than 4 μm on a first primer layer prior to applying the at least one finishing layer.

35. A method according to claim 33, further comprising depositing a hard base or a hard underlayer having no fluorocarbon resin directly on the support prior to applying the at least one primer layer thereto.

36. A method according to claim 33, further comprising anodizing the support prior to applying the at least one primer layer.

37. A method according to claim 33, further comprising applying a chemical or physical treatment to the support prior to applying the hard underlayer and/or the at least one primer layer.

38. A method according to claim 33, wherein the preparation lies in the range of 3% to 25%.

39. A method according to claim 33, wherein the preparation lies in the range of 5% to 15%.
